(19) United States
(12) Patent Application Publication
(10) Pub. No.: US 2005/0271154 A1
(43) Pub. Date: Dec. 8, 2005

(54) System for allocating radio resources in multiband OFDM system

(75) Inventors: Jae-ho Roh, Seoul (KR); Jae-hyun Koo, Seoul (KR); Jae-Min Ahn, Yongin-si (KR); Min-joong Rim, Seoul (KR); Sung-hyun Chung, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD.; ALOGICS CO., LTD.

(21) Appl. No.: 11/147,162

(22) Filed: Jun. 8, 2005

Related U.S. Application Data
(60) Provisional application No. 60/577,575, filed on Jun. 8, 2004.

(30) Foreign Application Priority Data
Apr. 26, 2005 (KR) 2005-34413

(51) Int. Cl. H04K 1/10; H04L 27/28

(52) U.S. Cl. 375/260

(57) ABSTRACT

A method for seamlessly receiving a symbol from a transmitting end at a receiving end even when error occurs in a certain radio resource of a multiband OFDM system that transmits a same symbol at least two times. The multiband OFDM system includes a transmitting end selecting two radio resources from at least three radio resources and consecutively transmitting a symbol using the selected radio resources, and a receiving end receiving the symbol from the transmitting end.

### CROSS-REFERENCE TO RELATED APPLICATIONS

This application claims the benefits from U.S. Provisional Application No. 60/577,575 filed on Jun. 8, 2004 in the United States Patent and Trademark Office, and Korean Patent Application No. 2005-34413 filed on Apr. 26, 2005 in the Korean Intellectual Property Office, the entire disclosures of which are incorporated herein by reference.

### BACKGROUND OF THE INVENTION

1. Field of the Invention

The present invention relates generally to a multiband orthogonal frequency division multiplexing (OFDM) system. More particularly, the present invention relates to a method for efficiently transmitting a symbol using a plurality of sub-bands in an orthogonal frequency division multiplexing (OFDM) system.

2. Description of the Related Art

The orthogonal frequency division multiplexing (OFDM) system converts incoming serial symbols into parallel symbols with a certain size, multiplexes and transmits the converted parallel symbols in different orthogonal carrier frequencies.

The multiband OFDM system transmits the OFDM symbols in a plurality of frequency bands by hopping (frequency hopping). For example, the multiband OFDM system is a modulation technique used in a particular wireless communication system such as an ultra wideband (UWB) system. The multiband OFDM modulation is combined with the frequency hopping technique. Hereinafter, the multiband OFDM system adopted to the UWB is explained in detail. The multiband OFDM system uses a plurality of sub-bands with a specified frequency band to transmit data (symbols) in the plurality of sub-bands. Accordingly, it is possible to transmit and receive more data within a time unit. The multiband OFDM system selects one of the plurality of sub-bands and utilizes the selected sub-band according to a pre-established rule to thus enhance the data security.

FIG. 1 depicts a plurality of sub-bands available in the multiband OFDM system. As shown in FIG. 1, the center frequencies of the frequency bands of the multiband OFDM system ranges from 3432 MHz to 10296 MHz. The frequency bands of the multiband OFDM system are split into five groups. Let the five groups be designated as a first group through a fifth group. The first through fourth groups consist of three sub-bands, respectively, and the fifth group consists of two sub-bands.

The center frequencies of the three sub-bands in the first group are 3432 MHz, 3960 MHz, and 4488 MHz, and that of the three sub-bands in the second group are 5016 MHz, 5544 MHz, and 6072 MHz. The center frequencies of the three sub-bands in the third group are 6600 MHz, 7128 MHz, and 7656 MHz, and that of the three sub-bands in the fourth group are 8184 MHz, 8712 MHz, and 9240 MHz. The center frequencies of the two sub-bands in the fifth group are 9768 MHz and 10296 MHz.

Table 1 shows the frequency bands used in the multiband OFDM system.

TABLE 1

| TFC | | | | | | |
|---|---|---|---|---|---|---|
| No. | Symbol 1 | | Symbol 2 | | Symbol 3 | |
| 1 | First | Second | Third | First | Second | Third |
| | sub- | sub-band | sub-band | sub-band | sub-band | sub-band |
| | band | | | | | |
| 2 | First | Third | Second | First | Third | Second |
| | sub- | sub-band | sub-band | sub-band | sub-band | sub-band |
| | band | | | | | |
| 3 | First | First | Second | Second | Third | Third |
| | sub- | sub-band | sub-band | sub-band | sub-band | sub-band |
| | band | | | | | |
| 4 | First | First | Third | Third | Second | Second |
| | sub- | sub-band | sub-band | sub-band | sub-band | sub-band |
| | band | | | | | |

In Table 1, the multiband OFDM system uses three sub-bands to transmit the symbols.

The following is an explanation of the multiband OFDM system that transmits symbols using three sub-bands in reference to FIG. 2 and Table 1. FIG. 2 illustrates time frequency code (TFC) No. 1 through No. 4. The multiband OFDM system transmits one symbol two times at a low data rate 53.3 Mbps through 200 Mbps. In Table 1 and FIG. 2A, the TFC No. 1 transmits the symbol 1 in the first sub-band and the second sub-band, transmits the symbol 2 in the third sub-band and the first sub-band, and transmits the symbol 3 in the second sub-band and the third sub-band.

Referring to FIG. 2B, the TFC No. 2 transmits the symbol 1 in the first sub-band and the third sub-band, transmits the symbol 2 in the second sub-band and the first sub-band, and transmits the symbol 3 in the third sub-band and the second sub-band. Referring to FIG. 2C, the TFC No. 3 transmits the symbol 1 two times only in the first sub-band, transmits the symbol 2 two times only in the second sub-band, and transmits the symbol 3 two times only in the third sub-band. Referring now to FIG. 2D, the TFC No. 4 transmits the symbol 1 two times only in the first sub-band, transmits the symbol 2 two times only in the third sub-band, and transmits the symbol 3 two times only in the second sub-band.

As illustrated in Table 1 and FIG. 2, the TFC No. 3 and the TFC No. 4 transmit one symbol in the same sub-band rather than in the different sub-bands. In this situation, if error occurs in the first sub-band, the TFC No. 3 and No. 4 cannot transmit the symbol 1. As for error in the second sub-band, the TFC No. 3 cannot transmit the symbol 2 and the TFC No. 4 cannot transmit the symbol 3. Error in the third sub-band may block the TFC No. 3 from transmitting the symbol 3 and the TFC No. 4 from transmitting the symbol 2.

Typically, a receiving end of the multiband OFDM system, upon receiving the symbol, first searches the first sub-band. In particular, the receiving end obtains necessary information from the symbol received in the first sub-band, and obtains necessary information from the symbols received in the second sub-band and the third sub-band using the obtained information.

In Table 1 and FIG. 2, there is a fixed interval between the receiving time of the first symbol and that of the second symbol that are received in the first sub-band at the TFC No. 1 and No. 2. However, as for the TFC No. 3 and No. 4, the first symbol and the second symbol in the first sub-band are consecutively received. To process the first symbol received in the first sub-band, the receiving end needs to give up the processing of the second symbol. In other words, as for the TFC No. 3 and No. 4, the receiving end does not have enough margin (the interval between the receiving time of the first symbol and that of the second symbol) to process the second symbol received in the first sub-band.

### SUMMARY OF THE INVENTION

The present invention has been provided to address the above-mentioned and other problems and disadvantages occurring in the conventional arrangement, and an aspect of the present invention provides a method for seamlessly receiving a symbol from a transmitting end at a receiving end even when error occurs in a certain radio resource of a multiband orthogonal frequency division multiplexing (OFDM) system that transmits a same symbol at least two times.

Another aspect of the present invention provides a method for guarantying enough time to process a symbol received at a receiving end in a multiband OFDM system.

To achieve the above aspects and/or features of the present invention, a multiband OFDM system includes a transmitting end selecting two radio resources from at least three radio resources and consecutively transmitting a symbol using the selected radio resources; and a receiving end receiving the symbol from the transmitting end.

The radio resources are frequency bands. The transmitting end may select a center frequency having a lowest frequency from at least three center frequencies, and transmit the symbol in a sub-band corresponding to the selected center frequency.

The transmitting end, which transmits a symbol 1 through a symbol 3 in that order, may transmit the symbol 1 and the symbol 3 in the first sub-band. The receiving end may search the first sub-band first when the symbol reception is detected.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIG. 1 illustrates frequency bands used for a multiband orthogonal frequency division multiplexing (OFDM) system;

FIGS. 2A through 2D illustrate exemplary symbol transmissions using three sub-bands in the multiband OFDM system;

FIG. 3 illustrates a structure of a preamble with respect to TFC No. 1 and TFC No. 2 of the multiband OFDM system;

FIGS. 4A through 4D illustrate exemplary symbol transmissions using three sub-bands in a multiband OFDM system according to an embodiment of the present invention; and

FIG. 5 illustrates exemplary preamble transmissions using three sub-bands in the multiband OFDM system according to an embodiment of the present invention.

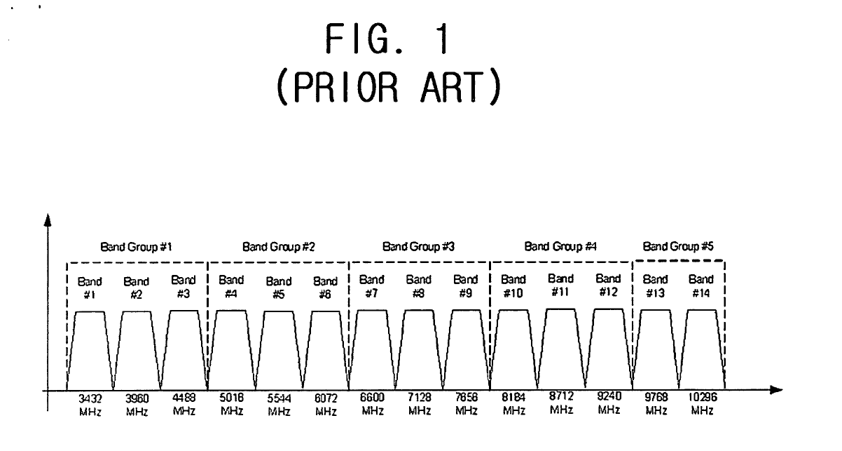

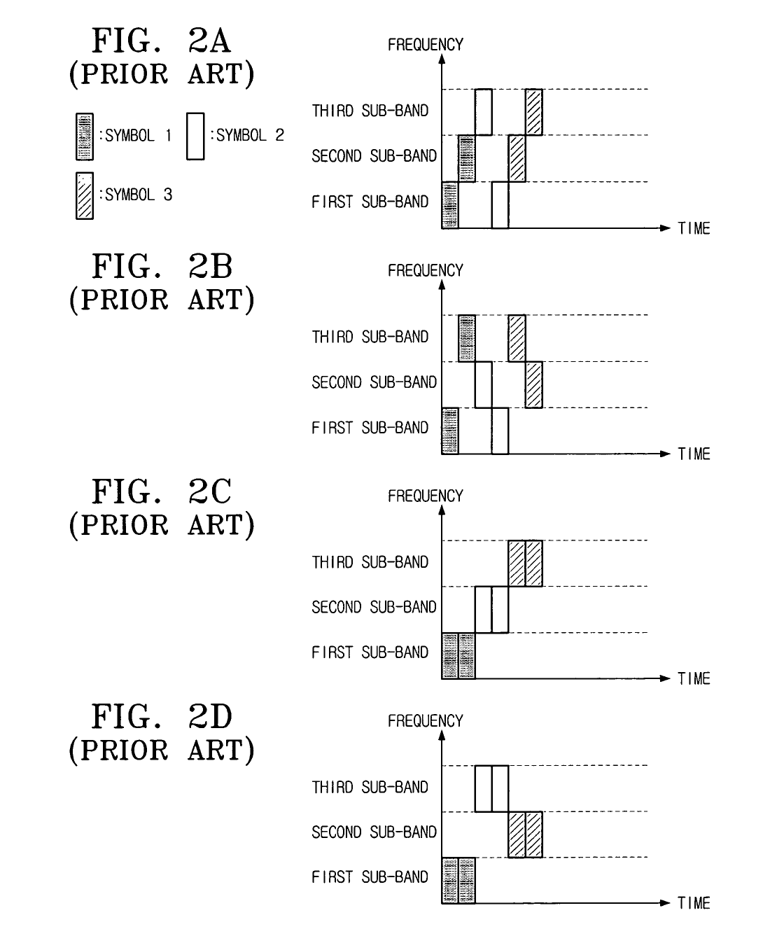

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The present invention suggests a method for transmitting the same symbol in different sub-bands.

Symbols used in a communication system are divided into a preamble and a payload. The preamble contains general information used to transmit the symbol in the communication system. The payload is substantial data transmitted from a transmitting end to a receiving end.

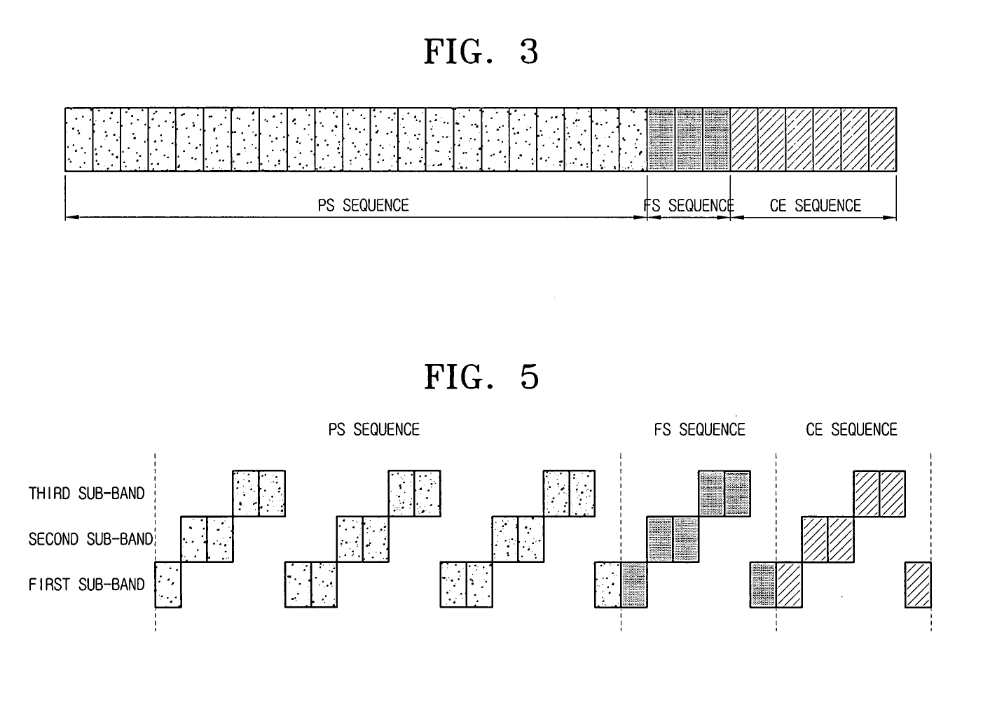

FIG. 3 depicts a structure of a preamble used in the multiband OFDM system with respect to time frequency code (TFC) No. 1 and No. 2. As illustrated in FIG. 3, the preamble includes a packet synchronization (PS) sequence consisting of 21 symbols, a frequency synchronization (FS) sequence consisting of 3 symbols, and a channel estimation (CE) sequence consisting of 6 symbols. Each symbol is 312.5 ns in length.

The PS sequence detects symbols, estimates a frequency (sub-band) used for the detected symbols, and acquires synchronization. The PS sequence calculates a gain with respect to the received symbols. The FS sequence detects an edge of the frame and discriminates between the PS sequence and the CE sequence using the detected information. The CE sequence estimates the channel.

Table 2 shows how the payload is transmitted according to its data rate in the multiband OFDM system.

TABLE 2

| Data rate (Mbps) | Modulation | Coding rate | TSF |
|---|---|---|---|
| 53.3 | QPSK | 1/3 | 2 |
| 55 | QPSK | 11/32 | 2 |
| 80 | QPSK | 1/2 | 2 |
| 106.67 | QPSK | 1/3 | 2 |
| 110 | QPSK | 11/32 | 2 |
| 160 | QPSK | 1/2 | 2 |
| 200 | QPSK | 5/8 | 2 |
| 320 | DCM | 1/2 | 1 |
| 400 | DCM | 5/8 | 1 |
| 480 | DCM | 3/4 | 1 |

For the data rate from 53.3 Mbps to 200 Mbps, the multiband OFDM system adopts the quadrature phase shift keying (QPSK) method. For the data rate from 320 Mbps to 480 Mbps, the dual carrier modulation (DCM) method is adopted.

When the data rate is between 53.3 Mbps and 200 Mbps, the time spreading factor (TSF) is 2. That is, for the data rate between 53.3 Mbps and 200 Mbps, the transmitting end of the multiband OFDM system transmits one symbol two times at time intervals.

Table 3 shows sub-bands used for the multiband OFDM system according to an embodiment of the present invention.

TABLE 3

| TFC | | | | | | |
|---|---|---|---|---|---|---|
| No. | Symbol 1 | | Symbol 2 | | Symbol 3 | |
| 1 | First | Second | Third | First | Second | Third |
| | sub- | sub-band | sub-band | sub-band | sub-band | sub-band |
| | band | | | | | |
| 2 | First | Third | Second | First | Third | Second |
| | sub- | sub-band | sub-band | sub-band | sub-band | sub-band |
| | band | | | | | |
| 3 | First | Second | Second | Third | Third | First |
| | sub- | sub-band | sub-band | sub-band | sub-band | sub-band |
| | band | | | | | |
| 4 | First | Third | Third | Second | Second | First |
| | sub- | sub-band | sub-band | sub-band | sub-band | sub-band |
| | band | | | | | |

As shown in Table 3, the multiband OFDM system transmits the symbols using three sub-bands.

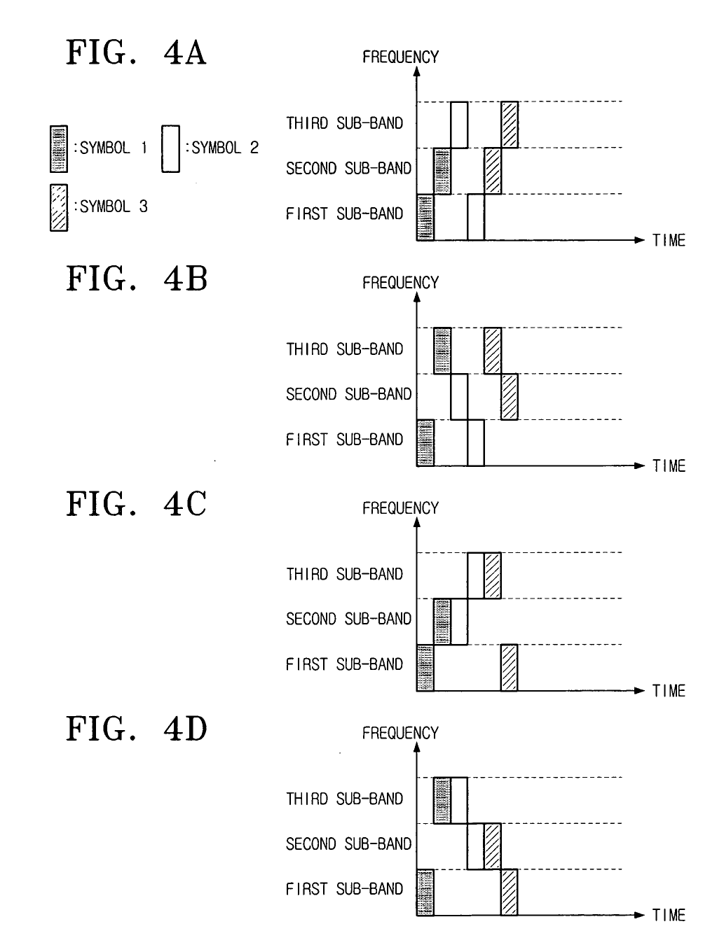

In the following, the multiband OFDM system to transmit symbols using three sub-bands is described in reference to FIG. 4 and Table 3. FIG. 4 depicts TFC No. 1 through No. 4. The preamble and the payload having a specific data rate carry a single symbol two times. In Table 3 and FIG. 4, the TFC No. 1 transmits the symbol 1 in the first sub-band and the second sub-band, transmits the symbol 2 in the third sub-band and the first sub-band, and transmits the symbol 3 in the second sub-band and the third sub-band.

The TFC No. 2 transmits the symbol 1 in the first sub-band and the third sub-band, transmits the symbol 2 in the second sub-band and the first sub-band, and transmits the symbol 3 in the third sub-band and the second sub-band. The TFC No. 3 transmits the symbol 1 in the first sub-band and the second sub-band, transmits the symbol 2 in the second sub-band and the third sub-band, and transmits the symbol 3 in the third sub-band and the first sub-band. The TFC No. 4 transmits the symbol 1 in the first sub-band and the third sub-band, transmits the symbol 2 in the third sub-band and the second sub-band, and transmits the symbol 3 in the second sub-band and the first sub-band.

As shown in Table 3, the multiband OFDM system transmits the symbol 1 in the first sub-band regardless of the TFC No. This is because the receiving end searches the first sub-band prior to others upon confirming the reception of the symbols. As the receiving end searches the first sub-band prior to others, the transmitting end transmits the symbol 1 in the first sub-band.

To secure a time to process the symbol 1 received in the first sub-band at the receiving end, the symbols are not consecutively transmitted in the first sub-band afterwards. As shown in Table 3, when transmitting two symbols 1 through two symbols 3 at a first point though a sixth point, the TFC No. 3 and the TFC No. 4 transmit the symbols in the first sub-band at the first point and the sixth point. Thus, the receiving end can process the symbol received at the first point until the symbol is received at the sixth point.

Referring back to Table 3, the symbol 2 of the TFC No. 3 is transmitted first in the second sub-band and then in the third sub-band. Note that the symbol 2 of the TFC No. 3 may be transmitted first in the third sub-band and then in the second sub-band according to the user's setting. In short, according to an embodiment of the present invention, the same symbol is transmitted in the different sub-bands.

Preferably, but not necessarily, the symbols at the first point and the sixth point are transmitted in the first sub-band since the receiving end of the multiband OFDM system searches the first sub-band prior to the others. Table 4 shows another example of the symbol transmission using three sub-bands in the multiband OFDM system.

TABLE 4

| TFC | | | | | | |
|---|---|---|---|---|---|---|
| No. | Symbol 1 | | Symbol 2 | | Symbol 3 | |
| 1 | First | Second | Third | First | Second | Third |
| | sub- | sub-band | sub-band | sub-band | sub-band | sub-band |
| | band | | | | | |
| 2 | First | Third | Second | First | Third | Second |
| | sub- | sub-band | sub-band | sub-band | sub-band | sub-band |
| | band | | | | | |
| 3 | First | Second | Third | Second | Third | First |
| | sub- | sub-band | sub-band | sub-band | sub-band | sub-band |
| | band | | | | | |
| 4 | First | Third | Second | Third | Second | First |
| | sub- | sub-band | sub-band | sub-band | sub-band | sub-band |
| | band | | | | | |

FIG. 5 depicts an exemplary transmission of the preamble by the TFC No. 3 based on Table 3, in which the preamble is transmitted in the three sub-bands. The multiband OFDM system selects one of the TFC No. 1 though No. 4. When neighbor devices transmit symbols using the same TFC number, the transmitted symbols are subject to collisions. To prevent this, the transmitting device and the receiving device recognize the TFC number used by the neighbor devices that transceive the symbols. The neighbor devices broadcast information relating to the TFC number used for the transmission and reception.

The transmitting device and the receiving device selects a TFC number, excluding the TFC number used by the neighbor devices, by association and transmits the symbols using the selected TFC number. Note that the association of selecting the TFC number is conducted in the MAC layer.

For example, given that the neighbor devices use the TFC No. 1 and No. 4, the transmitting device and the receiving device select one of the TFC No. 2 and No. 3.

As illustrated in FIG. 5, the multiband OFDM system according to an embodiment of the present invention transmits the symbols containing the same information in the different sub-bands so that the receiving end can acquire the delivered information from the transmitting end even when error occurs in a certain sub-band. As the symbols containing the same information are transmitted in the different sub-bands, the frequency diversity can be obtained. In addition, as the symbols containing the same information are transmitted at the specific time intervals, the time diversity and the frequency diversity can be realized.

FIG. 4 and FIG. 5 illustrate that the symbol groups consist of the three symbols and that each symbol is transmitted two times. It should be understood that each symbol can be transmitted two times in the symbol groups consisting of at least four symbols. For instance, suppose that the symbol group consists of four symbols, the transmitting end transmits the symbol 1 in the first sub-band and another sub-band and transmits the symbol 4 in the sub-band 1 and other sub-band.

As set forth above, the symbols containing the same information are transmitted using at least different radio resources so that the receiving end can receive the symbols via another radio resource even when error occurs in one radio resource. Since the symbols are not transmitted consecutively in the same radio resources, the time to process the received symbol can be guaranteed.

Although a few embodiments of the present invention have been shown and described, it would be appreciated by those skilled in the art that changes may be made in these embodiments without departing from the principles and spirit of the invention, the scope of which is defined in the claims and their equivalents.

1. A multiband orthogonal frequency division multiplexing (OFDM) system comprising:
a transmitting end selecting two radio resources from at least three radio resources and consecutively transmitting a symbol using the selected radio resources; and
a receiving end receiving the symbol from the transmitting end.

2. The multiband OFDM system of claim 1, wherein the radio resources are sub-bands having a center frequency.

3. The multiband OFDM system of claim 2, wherein the transmitting end selects a center frequency having a lowest frequency from at least three center frequencies, and transmits the symbol in a sub-band corresponding to the selected center frequency.

4. The multiband OFDM system of claim 3, wherein the radio resources include a first sub-band having a first center frequency through a third sub-band having a third center frequency.

5. The multiband OFDM system of claim 4, wherein the transmitting end, which transmits a symbol 1 through a symbol 3 in that order, transmits the symbol 1 and the symbol 3 in the first sub-band.

6. The multiband OFDM system of claim 4, wherein the receiving end searches the first sub-band when the symbol reception is detected.

7. The multiband OFDM system of claim 4, wherein the first center frequency of the first sub-band is lower than the third center frequency of the third sub-band.

8. The multiband OFDM system of claim 1, wherein the symbol includes a preamble and a payload among payloads at a data rate below 200 Mbps.

9. The multiband OFDM system of claim 1, wherein the transmitting end selects one transmission pattern from four transmission patterns and transmits the symbol using the selected transmission pattern.

10. The multiband OFDM system of claim 9, wherein the transmitting end selects a transmission pattern not to overlap with transmission patterns used by neighbor devices.
